(19) United States
(12) Patent Application Publication
(10) Pub. No.: US 2024/0264276 A1
(43) Pub. Date: Aug. 8, 2024

(54) RADAR-CAMERA OBJECT DETECTION

(71) Applicants: Ford Global Technologies, LLC, Dearborn, MI (US); Board of Trustees of Michigan State University, East Lansing, MI (US)

(72) Inventors: Yunfei Long, East Lansing, MI (US); Daniel Morris, Okemos, MI (US); Abhinav Kumar, East Lansing, MI (US); Xiaoming Liu, Okemos, MI (US); Marcos Paul Gerardo Castro, Mountainview, CA (US); Punarjay Chakravarty, Campbell, CA (US); Praveen Narayanan, Santa Clara, CA (US)

(73) Assignees: Ford Global Technologies, LLC, Dearborn, MI (US); Board of Trustees of Michigan State University, East Lansing, MI (US)

(21) Appl. No.: 18/423,694

(22) Filed: Jan. 26, 2024

Related U.S. Application Data
(60) Provisional application No. 63/483,098, filed on Feb. 3, 2023.

(51) Int. Cl. G01S 7/41; G01S 13/86; G01S 13/89; G01S 13/931

(52) U.S. Cl. CPC G01S 7/417; G01S 13/867; G01S 13/89; G01S 2013/9318; G01S 2013/93185; G01S 2013/9319

(57) ABSTRACT

A computer that includes a processor and a memory, the memory including instructions executable by the processor to generate radar data by projecting radar returns of objects within a scene onto an image plane of camera data of the scene based on extrinsic and intrinsic parameters of a camera and extrinsic parameters of a radar sensor to generate the radar data. The image data can be received at an image channel of an image/radar convolutional neural network (CNN) and receive the radar data at a radar channel of the image/radar CNN, wherein features are transferred from the image channel to the radar channel at multiple stages Image object features and image confidence scores can be determined by the image channel, and radar object features and radar confidences by the radar channel. The image object features can be combined with the radar object features using a weighted sum.

### CROSS-REFERENCE TO RELATED APPLICATION

This patent application claims priority to U.S. Provisional Patent Application No. 63/483,098 filed on Feb. 3, 2023, which is hereby incorporated by reference in its entirety.

### BACKGROUND

Computers can operate systems and devices including vehicles, robots, drones, and/or object tracking systems. Data including images can be acquired by sensors and processed by a computer to determine a location of a system with respect to an environment and with respect to objects in the environment. A computer may use the location data to determine one or more trajectories and/or actions for operating the system or components thereof in the environment.

### BRIEF DESCRIPTION OF THE DRAWINGS

FIG. 1 is a block diagram of an example vehicle system.

FIG. 2 is a diagram of an example vehicle including sensors.

FIG. 3 is a diagram of an example machine learning system that combines camera and radar object detection.

FIG. 4 is a diagram of an example portion of a machine learning system.

FIG. 5 is a diagram of another example machine learning system that combines camera and radar object detection.

FIG. 6 is a diagram of another example portion of a machine learning system.

FIG. 7 is a diagram of an image that combines an image from a camera with camera image and radar object detection output from a machine learning system.

FIG. 8 is a diagram of a birds-eye-view of output from a machine learning system that combines camera image and radar object detection.

FIG. 9 is a flowchart diagram of an example process to operate a vehicle based on machine learning system that combines camera image and radar object detection.

### DETAILED DESCRIPTION

Systems that move and/or that have mobile or movable components, including vehicles, robots, drones, cell phones etc., can be operated by acquiring sensor data, including data regarding an environment around the system, and processing the sensor data to determine locations of objects in the environment around the system. The determined location data could be processed to determine operation of the system or portions of the system. For example, a robot could determine the location of another nearby robot's arm. The determined robot arm location could be used by the robot to determine a path upon which to move a gripper to grasp a workpiece without encountering the other robot's arm. In another example, a vehicle could determine a location of another vehicle traveling on a roadway. The vehicle could use the determined location of the other vehicle to determine a path upon which to operate while maintaining a predetermined distance from the other vehicle. Vehicle operation will be used herein as a non-limiting example of system location determination in description below.

A machine learning system, for example including a convolutional neural network, can be trained to determine identities and locations of one or more objects included in the environment, for example roadways and vehicles. Convolutional neural networks can be trained to identify and locate objects included in data acquired by sensors included in a vehicle. Training a convolutional neural network can require a training dataset that can include thousands of video sequences that can include millions of images. In addition, training a machine learning system such as a convolutional neural network can require ground truth data for the images in the training dataset. Ground truth includes annotation data regarding the identities and locations of objects included in the training dataset acquired from a source other than the machine learning system, for example user annotation of the images in the training dataset.

Obtaining predictions from a machine learning system that with enhanced accuracy identify and locate objects in an environment around a vehicle can depend upon determining with a three-dimensional location of an object in an environment around a vehicle. Image data acquired from video cameras, for example, can be processed by a trained convolutional neural network to accurately determine a two-dimensional (2D) rectangular bounding box that encloses the object. Operation of a vehicle based on image data can be enhanced by determining three-dimensional (3D) bounding boxes for objects in an environment around the vehicle. 3D bounding boxes can be used to indicate the 3D location and orientation of the object with respect to the vehicle. Convolutional neural networks have been shown to be less accurate in determining 3D bounding boxes than 2D bounding boxes based on monocular (one camera) image data.

Determining a 3D bounding box for an object based on monocular image data can be enhanced by providing 3D location data from a second sensor included in a vehicle. For example, a lidar sensor, which uses a pulsed and/or modulated laser beam to determine a direction and distance to surfaces in an environment around a vehicle, can provide data that can be combined with camera image data to enhance the accuracy of 3D bounding box determination for objects. Combining lidar sensor data with image data is presently not regarded as a practical way to obtain reliable 3D bounding boxes because lidar sensors are not readily available for vehicles due to packaging issues and problems operating high-powered lasers in populated environments.

Techniques described herein for combining image data and radar data provide for combining image data and radar data to provide enhanced 3D bounding boxes for objects in an environment around a vehicle based on using convolutional neural network processing and a depth weighting neural network to fuse image data and radar data. Image data and radar data fused using techniques discussed herein can provide more accurate 3D bounding box data than monocular image data alone while using the same convolutional neural network architecture with the same computational resources as monocular image data processing alone. Thus, techniques described herein provide enhanced operation for machines such as vehicles.

Combining image and radar data can increase the accuracy of depth determination for 3D bounding boxes that surround objected detected in image data. Due to differences in techniques between monocular image depth perception and radar depth perception, alignment between object depth indicated by a center of a 3D bounding box, and object depth indicated by the center of a radar return, can be meters apart, e.g., as determined with reference to global coordinates, for the same object. Techniques described herein enhance radar returns to obtain more accurate object center detections. Image data and radar data are associated at both the detection level and the feature level. Detection level association means combining camera data and radar data when the camera data and radar data are indicated by pixel data in image arrays. Feature level association means combining camera data and radar data following extraction of features from the image arrays. Multiple different monocular image depths can be obtained to enhance associations between image and radar depths at pixel processing levels. Following pixel processing levels, enhanced feature fusion techniques based on confidence weighting enhance accuracy of depth determination for 3D bounding boxes. These techniques permit increased accuracy of depth determination while minimizing computational resources by sharing computation by combining image and radar data at multiple points in the computational process.

Disclosed herein is a method including generating radar data by projecting radar returns of objects within a scene onto an image plane of camera data of the scene based on extrinsic and intrinsic parameters of a camera and extrinsic parameters of a radar sensor to generate the radar data. Image data can be received at an image channel of an image/radar convolutional neural network (CNN) and receive the radar data at a radar channel of the image/radar CNN, wherein features are transferred from the image channel to the radar channel at multiple stages. Image object features and image confidence scores can be determined by the image channel, and radar object features and radar confidences by the radar channel. The image object features can be combined with the radar object features using a weighted sum based on image confidence scores and radar confidence scores. A classification feature block of the image/radar CNN includes one or more of the classification feature block that receives one or more classification features to determine an image class score based on the image object features and the radar object features and a regression feature block that receives one or more regression features that determine one or more of object offset, object depth, object size, object rotation, object velocity, object direction, and object center-ness based on the image object features and the radar object features.

Output of the image/radar CNN can include one or more of a depth fusion block that combines image object features and radar object features output by a head network including depth, location, orientation, size, and confidence for 3D bounding boxes surrounding objects included in image object features and radar object features. The radar channel can include an optical flow channel. One or more of the radar channels and the image channels can include a feature pyramid network. The radar returns can be projected onto the image plane of the camera is bounded by a depth range based on resolution levels of the image data and radar data. The image/radar CNN can be trained using a loss function based on summing classification loss, regression loss, attribute classification loss, direction loss, and center-ness loss for respective object features. The classification loss can be based on a focal loss function. The camera, the radar sensor, and the image/radar CNN are included in a vehicle and predictions output from the image/radar CNN can be used to operate the vehicle. The vehicle can be operated by controlling one or more of the vehicle propulsion, vehicle steering, or vehicle brakes based on the predictions output by the image/radar CNN. The regression loss can be based on a smooth L1 loss function. The attribute classification loss can be based on a softmax classification loss function. The direction loss can be based on a softmax classification loss function. The center-ness loss can be based on a binary cross entropy loss function.

Further disclosed is a computer readable medium, storing program instructions for executing some or all of the above method steps. Further disclosed is a computer programmed for executing some or all of the above method steps, including a computer apparatus, programmed to generate radar data by projecting radar returns of objects within a scene onto an image plane of camera data of the scene based on extrinsic and intrinsic parameters of a camera and extrinsic parameters of a radar sensor to generate the radar data. Image data can be received at an image channel of an image/radar convolutional neural network (CNN) and receive the radar data at a radar channel of the image/radar CNN, wherein features are transferred from the image channel to the radar channel at multiple stages. Image object features and image confidence scores can be determined by the image channel, and radar object features and radar confidences by the radar channel. The image object features can be combined with the radar object features using a weighted sum based on image confidence scores and radar confidence scores. A classification feature block of the image/radar CNN includes one or more of the classification feature block that receives one or more classification features to determine an image class score based on the image object features and the radar object features and a regression feature block that receives one or more regression features that determine one or more of object offset, object depth, object size, object rotation, object velocity, object direction, and object center-ness based on the image object features and the radar object features.

The instructions including further instructions wherein output of the image/radar CNN can include one or more of a depth fusion block that combines image object features and radar object features output by a head network including depth, location, orientation, size, and confidence for 3D bounding boxes surrounding objects included in image object features and radar object features. The radar channel can include an optical flow channel. One or more of the radar channels and the image channels can include a feature pyramid network. The radar returns can be projected onto the image plane of the camera is bounded by a depth range based on resolution levels of the image data and radar data. The image/radar CNN can be trained using a loss function based on summing classification loss, regression loss, attribute classification loss, direction loss, and center-ness loss for respective object features. The classification loss can be based on a focal loss function. The camera, the radar sensor, and the image/radar CNN are included in a vehicle and predictions output from the image/radar CNN can be used to operate the vehicle. The vehicle can be operated by controlling one or more of the vehicle propulsion, vehicle steering, or vehicle brakes based on the predictions output by the image/radar CNN. The regression loss can be based on a smooth L1 loss function. The attribute classification loss can be based on a softmax classification loss function. The direction loss can be based on a softmax classification loss function. The center-ness loss can be based on a binary cross entropy loss function.

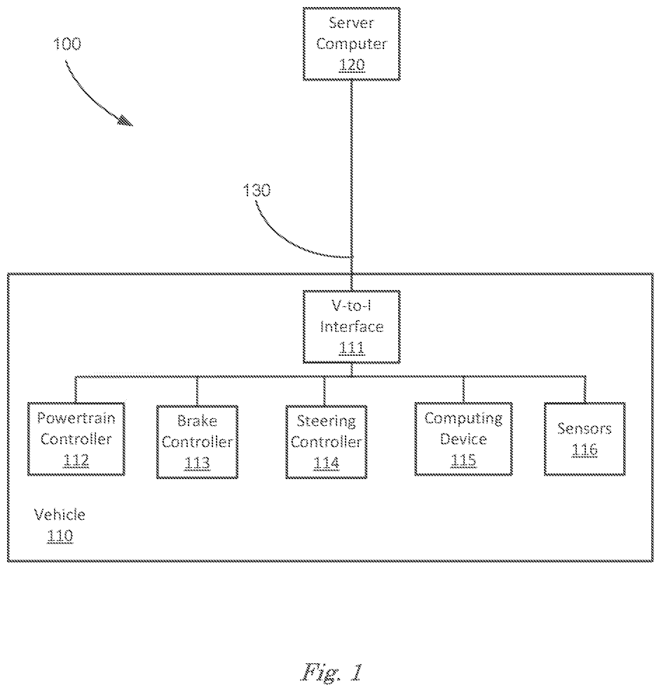

FIG. 1 is a diagram of vehicle computing system 100. Vehicle 110 is an example of a machine including components wherein in presently disclosed techniques can be implemented. Vehicle computing system 100 includes a vehicle 110, a computing device 115 included in the vehicle 110, and a server computer 120 remote from the vehicle 110. One or more vehicle 110 computing devices 115 can receive data regarding the operation of the vehicle 110 from sensors 116. The computing device 115 may operate vehicle 110 based on data received from the sensors 116 and data received from the remote server computer 120. The server computer 120 can communicate with the vehicle 110 via a network 130.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and exterior lights, etc., as well as to determine whether and when the computing device 115, as opposed to a human operator, is to control such operations. The computing device 115 can also control the temporal alignment of lighting to sensor acquisition to account for the color effects of vehicle lights or external lights.

The computing device 115 may include or be communicatively coupled to, i.e., via a vehicle communications bus as described further below, more than one computing devices, i.e., controllers or the like included in the vehicle 110 for monitoring and controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in vehicle 110 and receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2I) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and wireless networking technologies, i.e., cellular, BLUETOOTH®, Bluetooth Low Energy (BLE), Ultra-Wideband (UWB), Peer-to-Peer communication, UWB based Radar, IEEE 802.11, and other wired and wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2I) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and control various vehicle 110 components and operations. For example, the computing device 115 may include programming to control vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and control a specific vehicle subsystem. Examples include a propulsion controller 112, a brake controller 113, and a steering controller 114. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices such as are known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and other sensors 116 and the geographical coordinates provided by the GPS sensor may be used by the computing device 115 to operate the vehicle 110 autonomously or semi-autonomously, for example.

The vehicle 110 is generally a land-based vehicle 110 capable of autonomous and semi-autonomous operation and having two or more wheels, i.e., a passenger car, light truck, etc. Vehicle 110 includes one or more sensors 116, the V2I interface 111, the computing device 115 and one or more controllers 112, 113, 114. Sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Server computer 120 typically has features in common, e.g., a computer processor and memory and configuration for communication via a network 130, with the vehicle 110 V2I interface 111 and computing device 115, and therefore these features will not be described further to reduce redundancy. A server computer 120 can be used to develop and train software that can be transmitted to a computing device 115 in a vehicle 110.

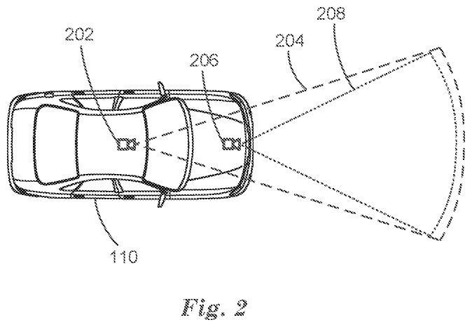

FIG. 2 is a diagram of vehicle 110 including a camera 202 and a radar sensor 206. Camera 202 has a field of view 204 and radar sensor 206 has a field of view 208. A field of view 204, 208 is a space from within which a camera 202 or a radar sensor 206, respectively, can obtain data. Field of view 204 is the region within which camera 202 can acquire color images of an environment around vehicle 110. Field of view 208 is the region within which radar sensor 206 can acquire range data to objects in an environment around vehicle 110. Acquired image data and acquired radar data can be received by a machine learning system included in a computing device 115 and processed to determine predictions regarding an environment around vehicle 110. A color image is defined as a multispectral image that samples the visible range of the electromagnetic spectrum. A color image can simulate a human response to panchromatic light or be tuned to enhance a particular portion of the spectrum, for example red light for low light detection. Radar data include acquired radar returns which are emitted radar emissions reflected by surfaces in the field of view 208. Radar data can also include Doppler data, which measures a shift in frequency of returned signals to generate velocity data for the acquired radar data points.

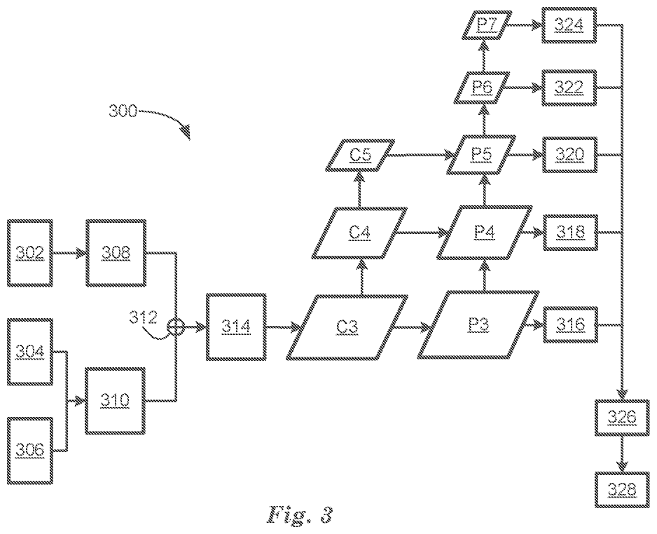

FIG. 3 is a diagram of image/radar CNN system 300 for determining object features based on image data 302 and radar data 304, and optical flow data 306. Radar data 304 includes both radar range data and radar Doppler data inserted into an x, y grid to match the locations of the radar data points with camera image data (sometimes hereinafter referred to simply as an “image” or “image data,” e.g., when contrasted with radar data) point locations in image data field of view 204. Optical flow data 306 can be generated by tracking data points over a sequence of two or more images to determine optical flow, which measures the movement of image data points over time. Optical flow data 306 can be matched with radar Doppler data by image/radar CNN system 300 to determine which radar range data points match which image data points.

Image data 302 is received by image data pre-processor 308. Image data pre-processor 308 is a single convolution layer that convolves the image data 302 with a 7×7 pixel square convolution kernel then reduces the resolution of the image data 302 by max pooling. Convolutional layers can convolve input arrays with square convolution kernels that are described by the number of pixels included in the kernel. Max pooling is an operation that replaces a neighborhood of pixels, in this example 2×2, with the maximum value of the pixels in the neighborhood. Radar data 304 and optical flow data 306 are combined by stacking bits to form two channels for each pixel by radar preprocessor 310 and processed by convolving the pixels with two layers of 3×3 convolutions followed by 2×2 max pooling to reduce the resolution of the stacked channels to match resolution of the image data 302. Image data pre-processor 308 and radar data pre-processor 310 uses camera intrinsics, and predetermined radar and camera extrinsics to project radar returns on the camera image plane.

Camera and radar intrinsics (i.e., intrinsic parameters) are equations that map pixel locations in the image or radar data to rays in space relative to an optical axis of the sensor. Camera extrinsics (i.e., extrinsic parameters) include data that describes where in x, y, z, roll, pitch, and yaw six-axis global coordinates the optical axis of the camera is located. Image pre-processor 308 and radar pre-processor 310 match the location and orientation of the image data 302 and radar data 304 so they can be combined by combiner 312 as channels included in a single image array. Flow block 314 is a single 1×1 convolution layer that further aligns the radar and image data by matching radar flow from Doppler radar with optical flow data 306.

Following pre-processing and alignment, the combined image and radar data is passed to the backbone processing layers C3, C4, C5. Backbone processing layers C3, C4, C5 and feature pyramid network layer P3, P4, P5, P6, P7 comprise a ResNet CNN trained for features included in objects for both image data 302 and radar data 304. The ResNet 101 CNN is described in Wang Tai, Zhu Xinge, Pang Jiangmiao, Lin Dahua. “FCOS3D: Fully Convolutional One-Stage Monocular 3D Object Detection.” International Conference on Computer Vision Workshops 2021. Backbone processing layer C3, C4, C5 detects object features for image data 302 and radar data 304 at three successively lower resolutions by decimating the image data using max pooling as described above. Decimating means removing a portion of the pixels of an image according to a rule such as max pooling.

All three resolutions of image data 302 and radar data 304 including object features are output to feature pyramid network layers P3, P4, P5 to determine classification features and regression features included in objects in both image data 302 and radar data 304. Feature pyramid network layers P3, P4, P5 also decimate data and pass it along to feature pyramid network layers P6, P7 to determine classification features and regression features for image data 302 and radar data 304 at lower resolutions. Classification features relate to what type of object is identified, and the confidence with which the object is identified in both image data 302 and radar data 304. Regression features measure the location, orientation, size and depth of the objects in both image data 302 and radar data 304. Regression features are used to determine 3D bounding boxes for objects in both image data 302 and radar data 304.

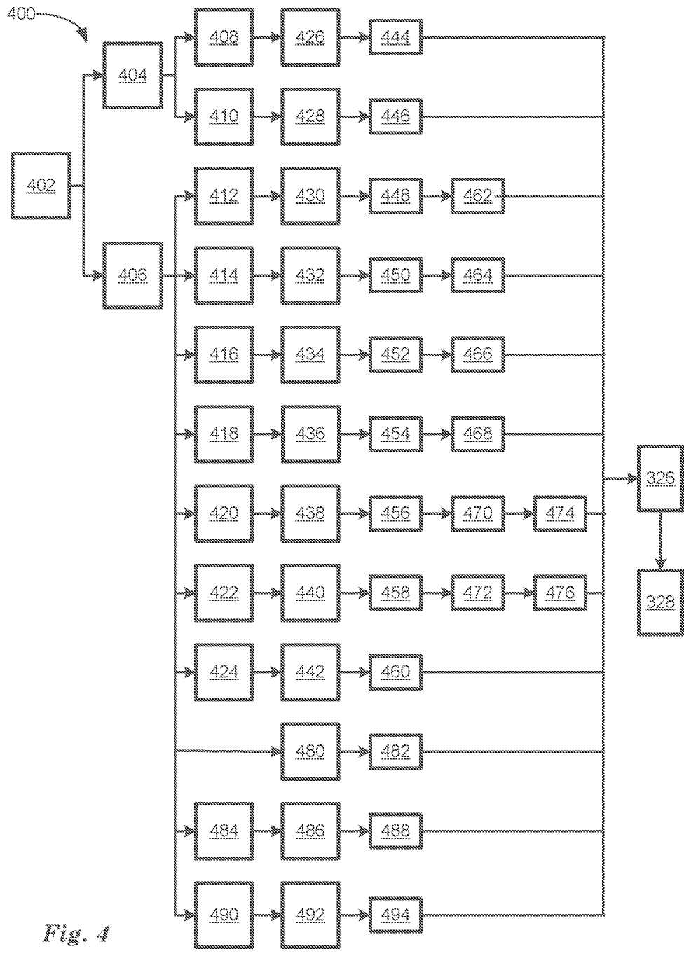

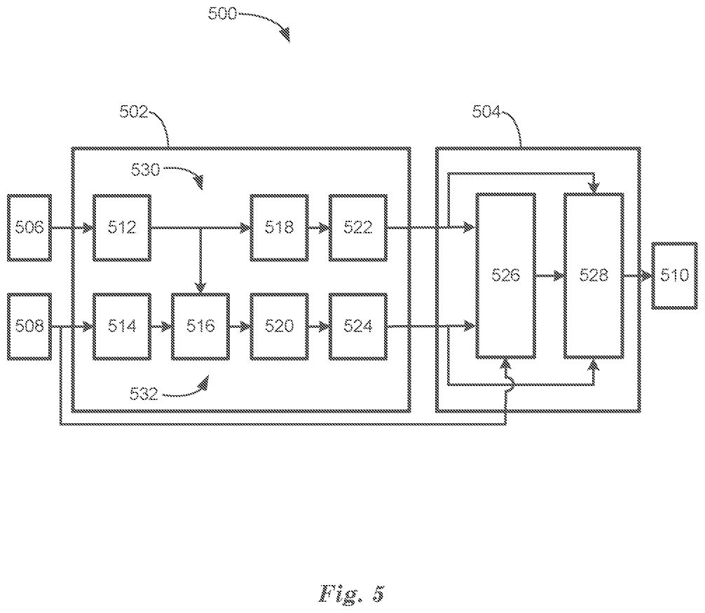

Feature pyramid network layers P3, P4, P5, P6, P7 output raw feature data and confidence values, which indicate a probability that the output raw feature data is accurate, to network feature blocks 316, 318, 320, 322, 324 at five different resolutions. Processing and raw feature data is processed by network feature blocks 316, 318, 320, 322, 324 to determine classification and regression features for both image and radar data and format them for further processing. Network feature blocks image and feature outputs are described in relation to FIG. 4, below. The processed classification and regression features for image and radar data along with confidence values are output to depth fusion 326. Depth fusion block 326 fuses features for both image data and radar data by combining the image and radar features spatially in the image plane of camera data using a weighted sum based on the confidence values output by network feature blocks 316, 318, 320, 322, 324. Depth fusion 326 outputs predictions 328 including depth, location, orientation, and size for 3D bounding boxes surrounding objects included in image data 302 and radar data 306. Output predictions 328 can be used by computing device 115 to operate a machine such as a vehicle 110. Depth fusion 326 is described in relation to FIG. 5, below.

Training the image/radar CNN system 300 may be accomplished by first training the image/radar CNN system 300 with image data 302 and ground truth that includes data regarding object features. Loss functions for image features can be determined based on a weighted sum of differences between classification and regression features and ground truth data. Ground truth data is data regarding values of features output from the image/radar CNN system 300 obtained from a source independent from the image/radar CNN system 300. Ground truth data is data deemed correct or accurate for the purposes of training the system 300. For example, users can determine ground truth data from physical measurements of a traffic scene and then acquire image and radar data of the traffic scene. When the image data and radar data is processed by the image/radar CNN system 300, the results can be compared to the ground truth to determine a loss function. The loss function is backpropagated through the layers of the image/radar CNN system 300 to select weights that program the operation of each layer of the image/radar CNN system 300. Training is achieved by minimizing the loss function over repeated trials by varying the weights included in the layers of the image/radar CNN system 300.

An image of the traffic scene and the physical measurements can be included in a training dataset on determining differences between image features and ground truth based on L1 (Manhattan or Taxicab) distances. L1 distances add the sum of x and y distances as opposed to Euclidian distances that measure the diagonal distance by taking the square root of the sum of the squared x and y distances, for example. To train additional radar channels described in relation to FIGS. 3 and 4, ground truth data on object features determined by measured radar returns is added to the camera data ground truth. Training the image/radar CNN system 300 by first training on image data 302 and then training on image data 302 and radar data 304 permits the image/radar CNN system 300 to predict the radar features and also predict the associated object features for each radar feature. To predict radar features, the image/radar CNN system 300 is trained to build an association mapping from radar features to the multiresolution network image feature outputs.

The loss function for training the image/radar CNN system 300 includes loss functions for classification features and loss functions for regression features. Classification features are category variables and regression features are real numbers. Category variables have one of a finite number of class values or descriptors, for example “car”, “truck”, “motorcycle,” etc. Real numbers can assume any one of an infinite number of values between upper and lower limits, for example. Classification features and regression features are described in relation to FIG. 4, below. The classification loss function Lets for classification features is determined based on a focal loss function:

$${L}_{cls} = - {α ( 1 - p )}^{γ} log p \qquad ( 1 )$$

Where p is the class probability of the object's occurrence in the dataset and α=0.25 and γ=2 are constants. A softmax classification loss function is used for the attribute classification loss Lₐₜₜᵣ.

The regression loss function L_{loc} for regression features is determined based on a smooth L1 loss function:

$${L}_{loc} = {\sum }_{b ∈ ( Δ x , Δ y , d , w , l , h , θ , {v}_{x} , {v}_{y} )} SmoothL 1 ( Δ b ) \qquad ( 2 )$$

where Δx, Δy are the difference is location of the center of the 3D bounding box from a user determined location in the image, dis the depth of the center of 3D bounding box from a user determined location in the traffic scene, w, l, h are the width, length and height of the 3D bounding box, θ is the orientation of the 3D bounding box and vₓ, v_{y} are the velocities of the object in the x and y directions. The weight of the Δx, Δy, w, l, h, θ features are 1, the weight of the d feature is 0.2 and the weight of the vₓ, v_{y} features are 0.05. The smooth LI function SmoothLI is defined as:

$$SmoothL 1 := ( x ) \to piecewise ( \vert x \vert < 1 , 0.5 {x}^{2} , \vert x \vert - 0.5 ) \qquad ( 3 )$$

Where x is the L1 (Manhattan or Taxicab) distance between the feature value and the ground truth value. A softmax classification loss function and binary cross entropy (BCE) loss function is used for direction loss L_{dir} and center-ness loss Let, respectively. An over-all loss L is determined by summing classification loss, regression loss, attribute classification loss, direction loss, and center-ness loss, yielding an overall loss function:

$$L = ( {L}_{cls} + {L}_{loc} + {L}_{attr} + {L}_{dir} + {L}_{ct} ) \qquad ( 4 )$$

FIG. 4 is a diagram of an example head network 400. Head network 400 is applied in machine learning system 300 as network feature block channels 316, 318, 320, 322, 324 to process object features output by a feature pyramid which is a set of data that includes multiple convolutional layers that each extract features from image data and then reduce the resolution of the image array data and pass it on to the next layer of the feature pyramid. The feature pyramid in this example includes pyramid network layers P3, P4, P5, P6, P7, which extract features at five different resolutions ranging from full resolution at pyramid network layer P3 at 512×512 pixel resolution, through pyramid network layer P4 at 256×256 pixel resolution, pyramid network layer P5 at 128×128 pixel resolution, pyramid network layer P6 at 64×64 pixel resolution, to pyramid network layer P7, at 32×32 pixel resolution. Head block 400 receives features 402 output by the feature pyramid network layers P3, P4, P5, P6, P7. Received features 402 are processed in two groups, classification features, which are category variables, and regression features, which are real numbers as defined above in relation to FIG. 3.

Classification feature block 404 processes the received object classification with a two stage 3×3 convolution block that divides the features into image object features and radar object features. In other examples the object classification features could include greater or fewer numbers of features that include other measures of object classification and location. Image object features are processed by image classification convolutional layers 408, 426 to generate an image class score 444 which indicates a probability that an object in the input image data 302 belongs to an object class, such as car, truck, motorcycle, etc. Radar object features are processed by radar object convolutional layers 410, 428 to generate a radar class score 446 which indicates a probability that an object in the input radar data 304 belongs to an object class, such as car, truck, motorcycle, etc.

Regression feature block 406 processes the received regression features with a two stage 3×3 convolution block that divides the features into three radar object features and seven image object features. The first radar object feature, radar depth 446, is processed by radar depth convolutional stages 412, 430 and a radar depth scale stage 448 to generate a feature that indicates radar depth 446, which is a distance in global coordinates from an object in the field of view 208 to a point in the vehicle 110. The second radar object feature, radar offset 464, is an x, y distance in pixels from the center of the radar object to the center of a 3D bounding box feature surrounding the image object. The radar offset feature is processed by radar offset convolutional stages 414, 432 and radar offset scale stage 450 to generate radar offset 464. The third radar object feature, depth offset 466, is a difference in global coordinates between the radar depth 446 and the distance from the center of a 3D bounding box feature surrounding the image object. The depth offset feature is processed by depth offset convolutional stages 416, 434 and depth offset scale stage 452 to generate depth offset 466.

The first image object feature, image offset 468, is processed by image offset convolutional stages 418, 436 and image offset scale 454 to generate image offset 468. Image offset 468 is the x and y distance in pixels of the center of a 3D bounding box surrounding the object to a selected point in the image. The second image object feature, image depth 474, is processed by image depth convolutional stages 420, 438, followed by depth scale 456 and depth exponentiation 470 to generate image depth 474. Image depth is the distance in global coordinates from the center of the 3D bounding box to a selected point in the image data. The third image object feature, image size 476, is processed by image size convolution stages 422, 440, followed by image size scale 472 and image size exponentiation 472 to generate image size 476. Image size is the length of the longest side of the 3D bounding box surrounding the object in image data 302.

The fourth image object feature, image rotation 460, is processed by image rotation convolutional stages 424, 442 to generate image rotation 460. Image rotation 460 is the orientation of the 3D bounding box measured as rotations roll, pitch, and yaw about the x, y, and z axes. The fifth image object feature, image velocity 482, is processed with image velocity convolutional stage 480. Image velocity 482 is determined based on image flow data 306 and radar data 304 Doppler measurements. The sixth image object feature, image direction class 488, is processed by image direction class convolutional stages 484, 486 to generate image directions class 488. Image directions class 488 measures the speed and direction of the object's motion with respect to vehicle 110. The seventh image object feature, image center-ness 494, is processed by image center-ness convolutional stages 490, 492. Image center-ness is a value that varies from 0 to 1 and measures how well the 3D bounding box fits the object and is used to detect low-quality 3D bounding boxes.

Head network 400 receives raw object features 402 from feature pyramid network layers P3, P4, P5, P6, P7 and outputs an image class score 444 and radar class score 446 and regression features 462, 464, 466, 468, 474, 476, 460, 482, 488, 494 to depth fusion 326. Depth fusion block 326 fuses features for both image data and radar data by combining the image and radar features spatially in the image plane using a weighted sum based on the confidence value output by network feature blocks 316, 318, 320, 322, 324. Depth fusion block 326 outputs predictions 328 including depth, location, orientation, size, and confidence for 3D bounding boxes surrounding objects included in image data 302 and radar data 306. Output predictions 328 can be used by computing device 115 to operate vehicle 115. Depth fusion block 326 is described in relation to FIG. 5, below.

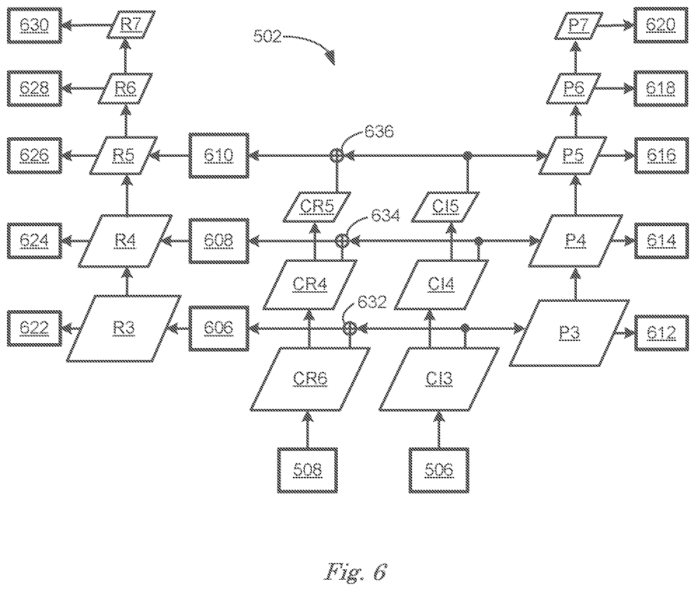

FIG. 5 is a diagram of another example of an image/radar machine learning system 500. Image/radar machine learning system 500 includes an image/radar CNN 502 and image/radar fusion block 504. Image/radar machine learning system 500 receives image data 506 and radar data 508 and outputs predictions 510 which include depth, location, orientation, size, and confidence for 3D bounding boxes surrounding objects included in image data 506 and radar data 508. Image/radar CNN 502 includes an image branch 530 which includes an image convolutional backbone 512, an image convolutional neck 518, and an image head 522. Image/radar CNN 502 also includes a radar branch 532 which includes a radar convolutional backbone, radar fusion block 516, radar convolutional neck block 520, and radar head block 524. Image/radar CNN 502 is described in more detail in relation to FIG. 6, below. Backbone blocks can be used for a variety of applications besides the example of object identification and location described herein. Convolutional neck blocks receive image array data from a backbone processors and extract features from the array data. Image or radar head blocks process features by receiving raw feature data from convolutional neck blocks and transform the raw data into feature predictions suitable for output and use in subsequent processing, for example vehicle operation.

Image/radar CNN 502 receives as input image data 506 and processes the image data 506 in image backbone convolutional block 512. Image/radar CNN 502 processes radar data 508 in radar backbone convolutional block 514. The processed image data 506 is combined with processed radar data 514 by concatenating the processed image data 506 with processed radar data 508 at radar fusion block 516. Image convolutional neck block 518 and image head block 522 generate raw image features and confidence levels and radar convolutional neck block 520 and radar head block 524 generate raw radar features and confidence levels. The raw image features, radar features and confidence levels for both are received by feature weight network 526. Feature weight network 526 is a neural network as described above in relation to FIG. 4 that determines weights for features and combines the weighted features with input radar data 508. The weighted features are combined with raw features at feature fusion block 528 which estimates the updated camera depth \hat{z}ᵢ; by the equation:

$${\hat{z}}_{i} = \{ \begin{matrix}\frac{{\sum }_{j} {α}_{j} {\hat{z}}_{j}^{r}}{{\sum }_{j} {α}_{j}} , & if ∃ j , {α}_{j} > {T}_{α} \\ {\hat{z}}_{i}^{c} , & if ∀ j , {α}_{j} \leq {T}_{α}\end{matrix} \qquad ( 5 )$$

Where i is the index of a camera detection with estimated depth \hat{z}ᵢ^{c},j is the index of a radar detection (with estimated depth \hat{z}ⱼ^{r}) associated with the camera detection i, αⱼ is the weight for \hat{z}ⱼ^{r},j determined by feature weight network 526 and T_{α} is a user determined weighting threshold.

Predictions regarding location, orientation, size, velocity, and depth of center for a 3D bounding box for an object can be output from image/radar machine learning system 500. The predictions can be output to a computing device 115 included in a vehicle 110 and used to operate the vehicle 110. Operating a vehicle 110 can include determining a vehicle path upon which to operate the vehicle. The vehicle path can be a polynomial function that includes vehicle locations and vehicle velocities determined with respect to a roadway, for example. Vehicle velocities include vehicle speed and vehicle orientation. The vehicle path can be determined to maintain a user determined relationship with respect to an object. For example, when the object is another vehicle, a vehicle path can be determined that limits the closest a vehicle 110 can approach another vehicle depending upon the relative speeds and direction. A vehicle 110 can be operated on the vehicle path by transmitting commands to vehicle controllers 112, 113, 114 to control vehicle propulsion, vehicle steering, and vehicle brakes to cause the vehicle 110 to travel on the vehicle path at the planned velocity.

FIG. 6 is a diagram of an image/radar CNN 502 that describes the processing elements included in the image/radar CNN 502 portion of image/radar machine learning system 500 from FIG. 5 in more detail. Image backbone convolutional block 512 includes image convolutional layers CI3, CI4, CI5, image pyramid layers P3, P4, P5, P6, P7 are included in image convolutional neck 518 and image feature networks 612, 614, 616, 618, 620 are included in image head 522. Radar backbone convolutional block 514 includes radar convolutional layers CR3, CR4, CR5, fusion convolutional layers 606, 608, 610 are included in radar fusion block 516, radar pyramid layers R3, R4, R5, R6, R7 are included in radar convolutional neck 520 and radar feature networks 622, 624, 626, 628, 630 are included in radar head 524.

Image convolutional layer CI3 inputs image data 506, convolves and reduces the image data 506 using max pooling and outputs the convolved and reduced image data 506 to image convolution layer CI4, image feature pyramid layer P3 and concatenation block 632. Image convolution layer CI4 inputs convolved and reduced image data 506, convolves and reduces it and outputs the convolved and reduced image data 506 to image convolution layer CI5, image feature pyramid layer P4 and concatenation block 634. Image convolution layer CI5 inputs convolved and reduced image data 506 from image convolutional layer CI4, convolves it and reduces and outputs it to image feature pyramid layer P5 and concatenation block 636. Radar convolutional layers CR3, CR4, CR5 input radar data 508, convolve it and reduce it to the same resolution as output from image convolutional layers CI3, CI4, CI5 using max pooling. Radar convolutional layers CR3, CR4, CR5 output the convolved and reduced radar data 508 to be concatenated with output from image convolutional layers CI3, CI4, CI5 by concatenation blocks 632, 634, 636, respectively. Concatenation blocks 632, 634, 636 generate fused image/radar data by concatenating the bits from image data 506 with radar data 508 at the same x, y location in the image arrays.

Concatenated image/radar data is output from concatenation blocks 632, 634, 636 to fusion convolutional networks 606, 608, 610, respectively. Fusion convolutional networks 606, 608, 610 condition the fused image/radar data for input to feature pyramid layers R3, R4, R5, respectively. Feature pyramid layers R3, R4, R5 combine input from fusion convolutional networks 606, 608, 610, respectively, with convolved and reduced data from previous feature pyramid layers R3, R4, R5. Feature pyramid layers R6, R7 convolve and reduce fused image/radar data from previous feature pyramid layers R5, R6. Convolved and reduced fused image/radar data is output from feature pyramid layers R3, R4, R5, R6, R7 to radar feature networks 622, 624, 626, 628, 630, respectively.

Image feature networks image feature networks 612, 614, 616, 618, 620 and radar feature networks 622, 624, 626, 628, 630 are neural networks that process image features and fused image/radar features as described above in relation to FIG. 4. Outputs from image feature networks 612, 614, 616, 618, 620 and radar feature networks 622, 624, 626, 628, 630 are received by image/radar fusion block 504 as described in relation to FIG. 5 above to determine predictions regarding location, orientation, size, velocity and depth of center for 3D bounding boxes for objects included in image data 506 and radar data 508.

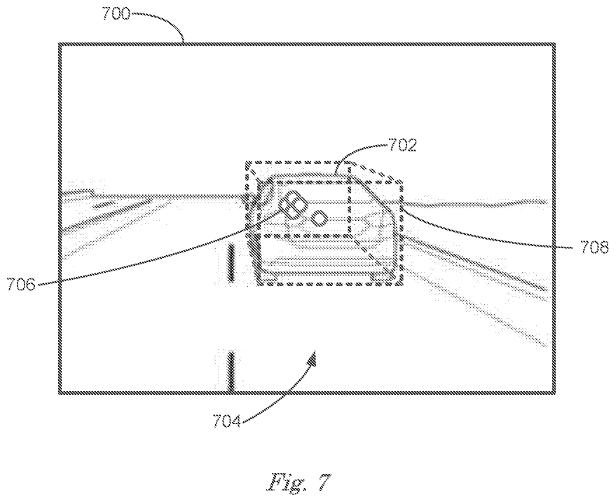

FIG. 7 illustrates an example image 700 of a traffic scene acquired from a camera 202 included in vehicle 110. Image 700 includes an object 702, in this example another vehicle, traveling on a roadway 704 in front of vehicle 110. Included in image 700 are radar returns 706 (circles), which indicate the depth or distance of the object 702 from vehicle 110. Also included in image 700 is a 3D bounding box 708 output determined based on image features output by image head 522, for example.

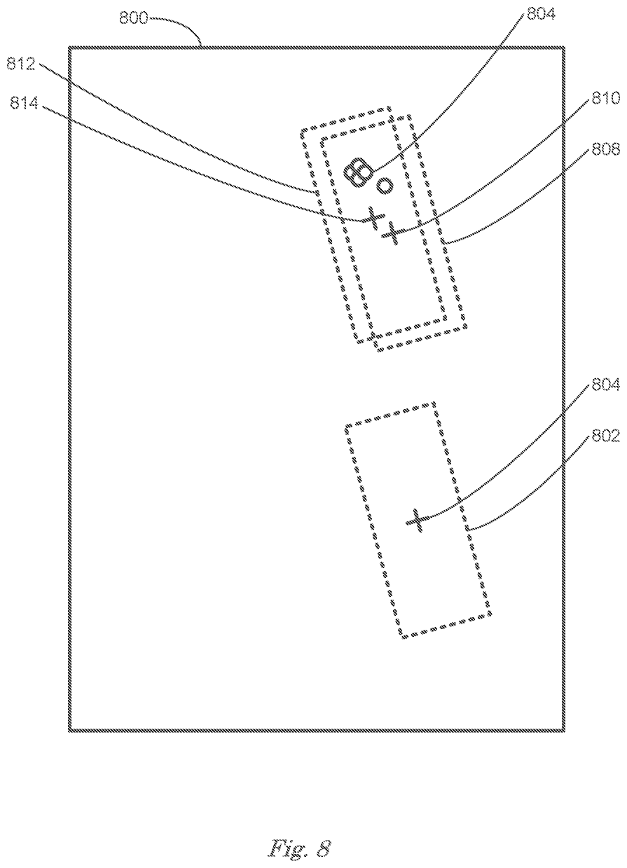

FIG. 8 illustrates a bird's-eye-view 800 of the traffic scene from FIG. 7. Image-based 3D bounding box 802 is a top view of 3D bounding box 708 from FIG. 7 output by image head 522. Image-based 3D bounding box 802 includes a center 804. Radar returns 806 (represented by circles in FIG. 8) are output from radar features 524. Corrected 3D bounding box 808 with center 810 is located in bird's-eye-view 800 based on locations of radar returns 806 following processing with feature weight network 526 and fusion block 528 according to equation (1), above. Ground truth 3D bounding box 812 having a center at 814 is included in bird's-eye-view 800 for reference. Location of ground truth 3D bounding box 812 is determined by measuring the location of object 702 independently from image/radar machine learning system 500, for example physical measurement of traffic scene. Combining radar depth measures with image-based depth measures using an image/radar machine learning system 500 as described herein can provide more accurate estimates of object 702 depth than image-based measurement alone while typically minimally increasing the required computing resources.

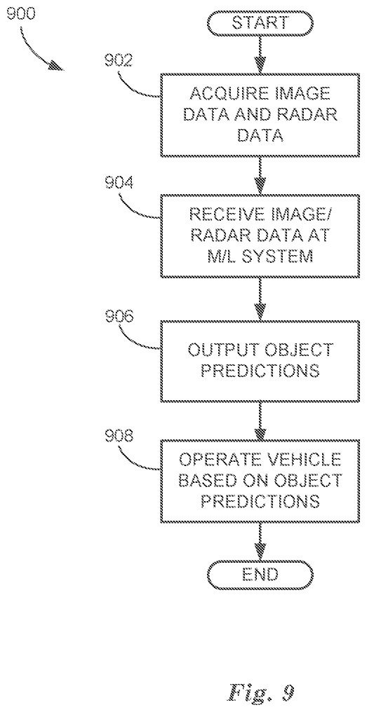

FIG. 9 is a flowchart of a process 900 for operating a machine, vehicle 110 in the illustrated example, with an image/radar CNN system 300, 500 using image data 302, 506 and radar data 304, 508. Process 900 can be implemented in a computing device 115 in a vehicle 110, for example. Process 900 includes multiple blocks that can be executed in the illustrated order. Process 900 could alternatively or additionally include fewer blocks and can include the blocks executed in different orders.

Process 900 begins at block 902, where a computing device 115 in a vehicle 110 acquires image data 302, 506 and radar data 304, 508 as described above in relation to FIG. 2, above.

At block 904 computing device 115 image data 302, 506 and radar data 304, 508 are received at an image/radar CNN system 300, 500. In some examples, optical flow data can be determined based on acquiring multiple images and determining optical flow based on movement of features over time. The optical flow data can be compared to Doppler radar to associate radar returns with moving objects to assist the image/radar CNN system 300, 500 in associating radar returns with image data,

At block 906 image/radar CNN system 300, 500 can output predictions regarding the location, orientation, size, velocity and depth of center for a 3D bounding box surrounding an object in an environment around vehicle 110.

At block 908 computing device 115 can receive the location, orientation, size, velocity and depth of center for a 3D bounding box surrounding an object in an environment around vehicle 110 and determine a vehicle path that maintains a user determined relationship between the vehicle 110 and the object. For example, computing device 115 can determine a vehicle path that applies vehicle steering to direct vehicle 110 away from the object or applies vehicle brakes to slow vehicle 110. Computing device 115 can transmit commands to vehicle controllers 112, 113, 114 to control one or more of vehicle propulsion, vehicle steering, and vehicle brakes to cause vehicle 110 to travel on the determined vehicle path. Following block 908 process 900 ends.

Any action taken by a vehicle or user of the vehicle in response to one or more navigation prompts disclosed herein should comply with all rules specific to the location and operation of the vehicle (e.g., Federal, state, country, city, etc.). Moreover, any navigation prompts disclosed herein are for illustrative purposes only. Certain navigation prompts may be modified and omitted depending on the context, situation, and applicable rules. Further, regardless of the navigation prompts, users should use good judgement and common sense when operating the vehicle. That is, all navigation prompts, whether standard or “enhanced,” should be treated as suggestions and only followed when safe to do so and when in compliance with any rules specific to the location and operation of the vehicle.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It should further be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention.

1. A system, comprising:
a computer that includes a processor and a memory, the memory including instructions executable by the processor to:
generate radar data by projecting radar returns of objects within a scene onto an image plane of camera data of the scene based on extrinsic and intrinsic parameters of a camera and extrinsic parameters of a radar sensor to generate the radar data;
receive image data at an image channel of an image/radar convolutional neural network (CNN) and receive the radar data at a radar channel of the image/radar CNN, wherein features are transferred from the image channel to the radar channel at multiple stages;
determine image object features and image confidence scores by the image channel, and radar object features and radar confidences by the radar channel; and
combine the image object features with the radar object features using a weighted sum based on image confidence scores and radar confidence scores.

2. The system of claim 1, wherein a classification feature block of the image/radar CNN includes one or more of:
the classification feature block that receives one or more classification features to determine an image class score based on the image object features and the radar object features; and
a regression feature block that receives one or more regression features that determine one or more of object offset, object depth, object size, object rotation, object velocity, object direction, and object center-ness based on the image object features and the radar object features.

3. The system of claim 1, wherein output of the image/radar CNN includes one or more of:
A depth fusion block that combines image object features and radar object features output by a head network including depth, location, orientation, size, and confidence for 3D bounding boxes surrounding objects included in image object features and radar object features.

4. The system of claim 1, wherein the radar channel includes an optical flow channel.

5. The system of claim 1, wherein one or more of the radar channels and the image channels include a feature pyramid network.

6. The system of claim 1, wherein projecting the radar returns onto the image plane of the camera is bounded by a depth range based on resolution levels of the image data and radar data.

7. The system of claim 1, wherein the image/radar CNN is trained using a loss function based on summing classification loss, regression loss, attribute classification loss, direction loss, and center-ness loss for respective object features.

8. The system of claim 7, wherein the classification loss is based on a focal loss.

9. The system of claim 1, wherein the camera, the radar sensor, and the image/radar CNN are included in a vehicle and predictions output from the image/radar CNN are used to operate the vehicle.

10. The system of claim 9, wherein the vehicle is operated by controlling one or more of vehicle propulsion, vehicle steering, or vehicle brakes based on the predictions output by the image/radar CNN.

11. A method, comprising:
generating radar data by projecting radar returns of objects within a scene onto an image plane of camera data of the scene based on extrinsic and intrinsic parameters of a camera and extrinsic parameters of a radar sensor to generate the radar data;
receiving image data at an image channel of an image/radar convolutional neural network (CNN) and receive the radar data at a radar channel of the image/radar CNN, wherein features are transferred from the image channel to the radar channel at multiple stages;
determining image object features and image confidence scores by the image channel, and radar object features and radar confidences by the radar channel; and
combining the image object features with the radar object features using a weighted sum based on image confidence scores and radar confidence scores.

12. The method of claim 11, wherein a classification feature block of the image/radar CNN includes one or more of:
the classification feature block that receives one or more classification features to determine an image class score based on the image object features and the radar object features; and
a regression feature block that receives one or more regression features that determine one or more of object offset, object depth, object size, object rotation, object velocity, object direction, and object center-ness based on the image object features and the radar object features.

13. The method of claim 11, wherein output of the image/radar CNN includes one or more of:
a depth fusion block that combines image object features and radar object features output by a head network including depth, location, orientation, size, and confidence for 3D bounding boxes surrounding objects included in image object features and radar object features.

14. The method of claim 11, wherein the radar channel includes an optical flow channel.

15. The method of claim 11, wherein one or more of the radar channels and the image channels include a feature pyramid network.

16. The method of claim 11, wherein projecting the radar returns onto the image plane of the camera is bounded by a depth range based on resolution levels of the image data and radar data.

17. The method of claim 11, wherein the image/radar CNN is trained using a loss function based on summing classification loss, regression loss, attribute classification loss, direction loss, and center-ness loss for respective object features.

18. The method of claim 17, wherein the classification loss is based on a focal loss function.

19. The method of claim 11, wherein the camera, the radar sensor, and the image/radar CNN are included in a vehicle and predictions output from the image/radar CNN are used to operate the vehicle.

20. The method of claim 19, wherein the vehicle is operated by controlling one or more of the vehicle propulsion, vehicle steering, or vehicle brakes based on the predictions output by the image/radar CNN.
